(19) United States
(12) Patent Application Publication
(10) Pub. No.: US 2007/0201048 A1
(43) Pub. Date: Aug. 30, 2007

(54) SYSTEM AND METHOD FOR ORDERING A PRINT OF A DIGITALLY REPRESENTED STILL IMAGE

(76) Inventor: Charles L. DuBois, Rochester, NY (US)

Correspondence Address: Dennis B. Danella, Esq.;JAECKLE FLEISCHMANN & MUGEL, LLP, 190 Linden Oaks, Rochester, NY, 14625-2812, US

(21) Appl. No.: 11/676,794

(22) Filed: Feb. 20, 2007

Related U.S. Application Data
(60) Provisional application No. 60/776,271, filed on Feb. 24, 2006.

(51) Int. Cl. G06F 3/12

(52) U.S. Cl. 358/1.1; 358/1.18

(57) ABSTRACT

A method for ordering a print of at least one digitally represented still image using a remote computer is provided, wherein each still image is a separate data file. The method may include the steps of selecting a data file representative of a digitally represented still image using the remote computer; selecting a print format for the digitally represented still image; establishing a print order data file which includes the selected print format for the digitally memory using the remote computer thereby allowing the saved print order data file to be subsequently communicated to a photofinisher or a Kiosk to produce and deliver the print. Further, a method of splitting a print order is provided so that different delivery criteria may be established on an item-by-item basis within the same print order data file.

### CROSS-REFERENCE TO RELATED APPLICATIONS

This application claims the benefit of U.S. Provisional Patent Application Ser. No. 60/776,271, filed Feb. 24, 2006.

### FIELD OF THE INVENTION

The present invention generally relates to a system and method for ordering a print of a digitally represented still image. In particular, the present invention relates to selecting a print format for the digitally represented still image, establishing a print order data file, and optionally saving the print order data file using a remote computer. The present invention further includes subsequently establishing a connection with a photofinisher or Kiosk so that the print order data file may be communicated to the photofinisher or Kiosk to produce and deliver the print of a digitally represented still image.

### BACKGROUND OF THE INVENTION

Digital photo image processing is a rapidly growing technology area. Digital cameras are in wide use today and a user has many options as to how the digital images are converted to a photograph. For example, the user may simply download the image to a computing device for printing directly from the digital camera or via a personal computer where the user may edit or otherwise modify the image as desired. Another option currently available is to physically deliver or send the digital image electronically to a photofinisher or Kiosk that will print and mail the desired photos or other product having the image printed thereon back to the user.

The present invention relates to the second option where a photofinisher is used to print digitally represented still images. One method of providing the photofinisher with a digitally represented still image is for the user to physically take the stored digitally represented image to the photofinisher, perform any edits and modifications to the digital images while present at the photofinisher, and then provide the modified version of the digital image to the photofinisher for printing. This process is inefficient since it may take a significant amount of time to make the desired modifications and edits to the digital images. Given that there typically are a limited number of editing stations at the photofinisher, the user may feel rushed when making modifications to the digital images if other people are waiting to use the editing station. Further, the editing process could take an extended period of time if the user is unfamiliar with the editing tools and devices provided at the photofinisher.

Another method of providing the photofinisher with digitally represented still images is by accessing the photofinisher through a network, such as the Internet. Using this particular method, the user logs onto the Internet and uses a website provided by the photofinisher to edit and provide the photofinisher with the digital image for printing. However, this method also has drawbacks since the Internet connection must be maintained throughout the print ordering process. For a user who uses a dial-up connection with only one phone line, any time spent connected to the Internet prevents incoming calls from being received which may be undesirable.

Accordingly, there exists a need for a system and method that reduces the amount of time that is spent at a photofinisher when a print order is physically delivered to the photofinisher. In addition, there is a need for a system and method that reduces the amount of time that needs to be spent connected to the photofinisher through a network when placing a print order with the photofinisher. The present invention fills these needs as well as other needs.

### SUMMARY OF THE INVENTION

In order to overcome the above stated problems, the present invention provides a system and method for ordering a print of at least one digitally represented still image using a remote computer, wherein each still image may be a separate data file. The method comprises the steps of selecting a data file representative of a digitally represented still image using the remote computer; selecting a print format for the digitally represented still image; establishing a print order data file which includes the selected print format for the digitally represented still image; and optionally saving the print order data file in a memory using the remote computer. Thereafter, the print order data file may be subsequently communicated to at least one of a photofinisher and a Kiosk using a network connection or directly delivering the print order data file to the photofinisher or Kiosk to produce the print on a photograph paper, poster, mug, calendar, mouse pad, magnet, ornament, plate, puzzle, or T-shirt.

The remote computer may include a graphical user interface including a display and a user interface selection device, whereby the method further comprises the step of displaying the digitally represented still image on the display after the data file representative of the digitally represented still image is selected. In addition, the method may further include the step of editing the digitally represented still image after the digitally represented still image is displayed.

Moreover, the method may include the step of selecting a delivery criteria after selecting a print format for the digitally represented still image, wherein the print order data file includes the selected print format and delivery criteria for the digitally represented still image. The delivery criteria may include one of a delivery location for the print, a delivery time for the print, or a delivery method for the print.

A second embodiment of the present invention relates to a method of splitting a print order data file so that different delivery criteria may be established for each print format contained within the same print order data file. This particular method includes selecting a first data file representative of a first digitally represented still image using the remote computer; selecting a second data file representative of a second digitally represented still image using the remote computer; selecting a first print format for the first digitally represented still image; establishing a print order data file which includes the first print format for the first digitally represented still image; splitting the print order data file into a first sub-order and a second sub-order, the first sub-order including the established print format for the first digitally represented still image; selecting a second print format for the second digitally represented still image and placing second print format in the second sub-order; selecting a first delivery criteria for the first digitally represented still image; selecting a second delivery criteria for the second digitally represented still image, wherein the first and second delivery criteria are different; and saving the print order data file including the first and second sub-orders in a memory using the remote computer, thereby allowing the saved print order data file to be subsequently communicated to at least one of a photofinisher and a Kiosk to produce the print.

### BRIEF DESCRIPTION OF THE DRAWINGS

The above-mentioned and other features and advantages of this invention, and the manner of attaining them, will become apparent and be better understood by reference to the following description of the invention in conjunction with the accompanying drawing, wherein:

FIG. 1 generally illustrates a networking environment in which the present invention may be used;

FIG. 2 is a block diagram generally illustrating a computer environment in which the invention may be used;

FIG. 3 is a block diagram generally illustrating a photofinisher that may be used in accordance with the present invention;

FIG. 4 generally illustrates another type of networking environment in which the present invention may be used;

FIG. 5 is a block diagram generally illustrating a Kiosk that may be used in accordance with the present invention;

FIG. 6 is a flow chart illustrating a method in accordance with a first embodiment of the present invention;

FIGS. 7-18 generally illustrate views displayed on the remote computer produced during implementation of a system and method for ordering digitally represented images in accordance with the present invention;

FIG. 19 is a flow chart illustrating a method in accordance with a second embodiment of the present invention; and

FIGS. 20 and 21 generally illustrate views displayed on the remote computer produced during implementation of a system and method for ordering digitally represented images in accordance with the second embodiment of the present invention.

### DETAILED DESCRIPTION OF A PREFERRED EMBODIMENT

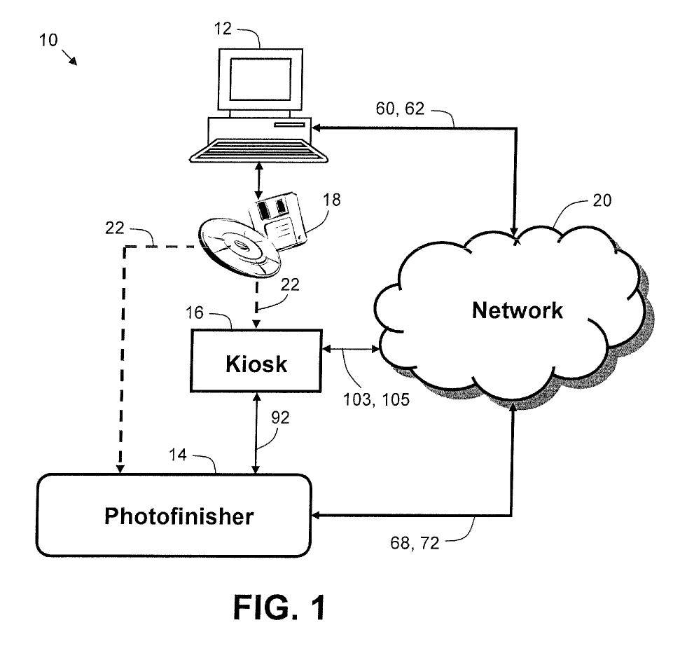

With reference to the drawings, an exemplary environment or system for implementing the present invention is shown in FIG. 1 and is designated as reference numeral 10. The system 10 may include a general purpose computing device 12 that is remotely located relative to a photofinisher 14 and, optionally, a Kiosk 16. In general, the present invention relates to using remote computer 12 to order a print of at least one digitally represented still image from photofinisher 14 or Kiosk 16. In particular, the present invention involves using remote computer 12 to select a data file representative of a digitally represented still image, select a print format for the digitally represented still image, establish a print order data file that includes the print format, and optionally saving the print order data file on remote computer 12 or a type of removable memory storage 18 (e.g., CD, floppy disk, flash drive). Subsequently, the print order data file may then be uploaded or otherwise communicated to at least one of photofinisher 14 and Kiosk 16 by a user or customer (hereinafter referred to as “user”) through a network 20, or by the user physically taking 22 the print order data file located on removable memory storage 18 to the photofinisher 14 or Kiosk 16 to place the print order. Thereafter, the photofinisher 14 or Kiosk 16 processes and delivers the print of the digitally represented still image to the user or a third-party designated by the user in accordance with the user defined delivery criteria.

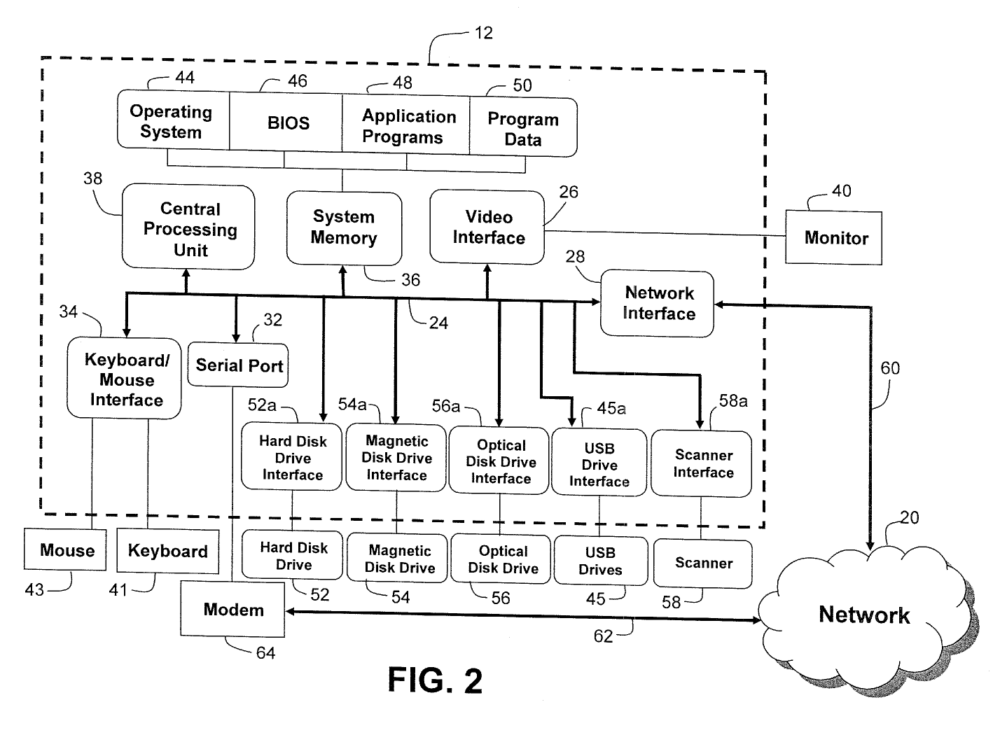

As best seen in FIG. 2, remote computer 12 may be a personal computer including a system bus 24 that couples a video interface 26, network interface 28, one or more serial ports 32, a keyboard/mouse interface 34, and a system memory 36 to a Central Processing Unit (CPU) 38. A monitor or display 40 is connected to bus 24 by video interface 26 and provides the user with a graphical user interface to view, edit, and prepare a print order data file using the digitally represented still images. The graphical user interface allows the user to enter commands and information into remote computer 12 using a keyboard 41 and a user interface selection device 43, such as a mouse or other pointing device. Keyboard 41 and user interface selection device are connected to bus 24 through keyboard/mouse interface 34. The display 40 and user interface selection device 43 are used in combination to form the graphical user interface which allows the user to implement at least a portion of the present invention. Other peripheral devices may be connected to remote computer through serial port 32 or universal serial bus (USB) drives 45 to transfer information to and from remote computer 12. For example, cameras and camcorders may be connected to remote computer 12 through serial port 32 or USB drives 45 so that data representative of a digitally represented still image or video may be downloaded to system memory 36 or another memory storage device associated with remote computer 12 so that the images may be subsequently printed by photofinisher 14 or Kiosk 16 in accordance with the present invention.

The system memory 36 is also connected to bus 24 and may include read only memory (ROM), random access memory (RAM), an operating system 44, a basic input/output system (BIOS) 46, application programs 48 and program data 50. The remote computer 12 may further include a hard disk drive 52 for reading from and writing to a hard disk, a magnetic disk drive 54 for reading from and writing to a removable magnetic disk (e.g., floppy disk), and an optical disk drive 56 for reading from and writing to a removable optical disk (e.g., CD ROM or other optical media). The remote computer 12 may also include USB drives 45 and other types of drives for reading from and writing to flash memory devices (e.g., compact flash, memory stick/PRO and DUO, SD card, multimedia card, smart media xD card), and a scanner 50 for scanning items such as still image photographs to be downloaded to remote computer 12. A hard disk interface 52a, magnetic disk drive interface 54a, a optical drive interface 56a, a USB drive interface 45a, and a scanner interface 58a operate to connect bus 24 to hard disk drive 52, magnetic disk drive 54, optical disk drive 56, USB drive 45 and a scanner 58, respectively. Each of these drive components and their associated computer-readable media may provide remote computer 12 with non-volatile storage of computer-readable instruction, program modules, data structures, application programs, an operating system, and other data for the remote computer 12. In addition, it will be understood that remote computer 12 may also utilize other types of computer-readable media in addition to those types set forth herein, such as digital video disks, random access memory, read only memory, other types of flash memory cards, magnetic cassettes, and the like.

Remote computer 12 may operate in a networked environment using logical connections with photofinisher 14 and Kiosk 16. Network interface 28 provides a communication path 60 between bus 24 and network 20, which allows a print order data file to be communicated through network 20 to photofinisher 14 after the print order data file has been established, and optionally saved in a memory, using remote computer 12. This type of logical network connection is commonly used in conjunction with a local area network (LAN). The print order data file may also be communicated from bus 24 through a communication path 62 to network 20 using serial port 32 and a modem 64. Using a modem connection between the remote computer 12 and photofinisher 14 is commonly used in conjunction with a wide area network (WAN). It will be appreciated that the network connections shown herein are merely exemplary, and it is within the scope of the present invention to use other types of network connections between remote computer 12 and photofinisher 14 including both wired and wireless connections.

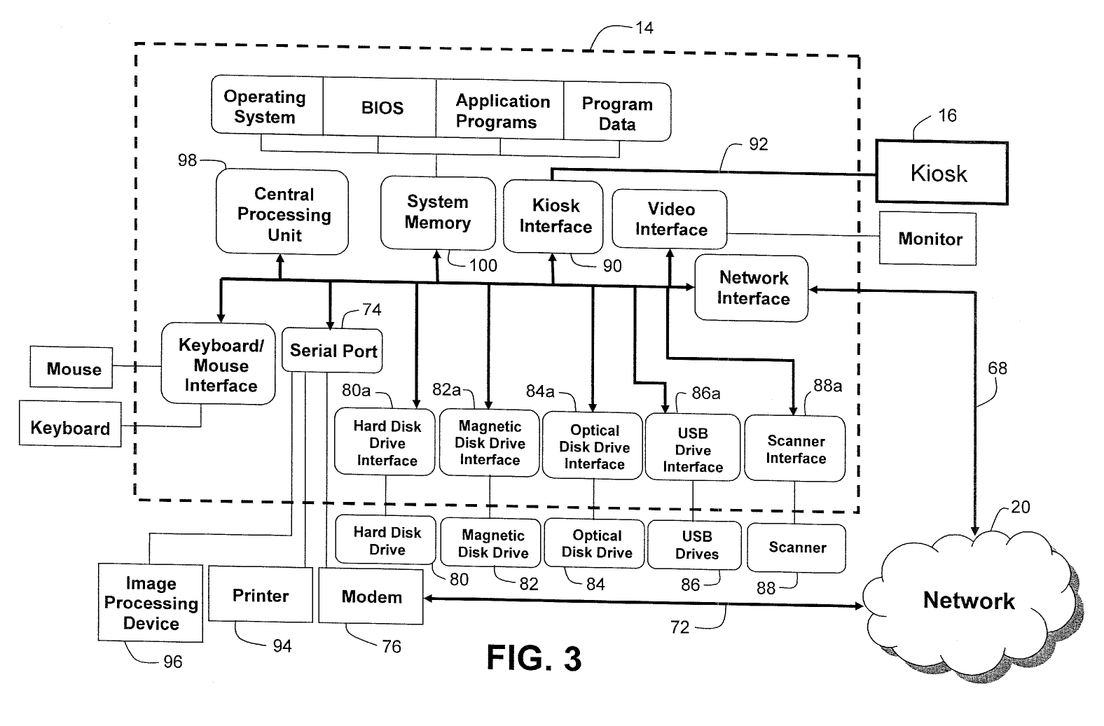

An exemplary photofinisher 14 is shown in FIGS. 1 and 3 and includes many of the components that were described with respect to remote computer 12. In general, photofinisher 14 is initially disconnected or otherwise has no communication with remote computer 12 when the print order data file is being established using remote computer 12. After the print order data file is established and optionally saved in a memory using remote computer 12, the print order data file is uploaded or otherwise communicated to photofinisher 14 so that the print of the digitally represented still image may be processed and delivered to the user or third-party designated by the user based on the user defined delivery criteria.

Photofinisher 14 may include a network interface 66 that provides a communication path 68 between a bus 70 and network 20, which allows the print order data file to be uploaded or otherwise communicated through network 20 to photofinisher 14 after the print order data file has been established using remote computer 12. The print order data file from remote computer 12 may also be communicated from bus 70 through a communication path 72 to network 20 using serial port 74 and a modem 76. As mentioned above, it will be appreciated that the network connections shown herein are merely exemplary, and it is within the scope of the present invention to use other types of network connections between remote computer 12 and photofinisher 14 including wired and wireless connections.

With specific reference to FIG. 3, photofinisher 14 may also include a hard disk drive interface 80a, a magnetic drive interface 82a, a optical drive interface 84a, a USB drive interface 86a, and a scanner interface 88a, which operate to connect bus 70 to hard disk drive 80, magnetic disk drive 82, optical disk drive 84, USB drives 86 and a scanner 88, respectively, so that data representative of digitally represented digital images may be uploaded to photofinisher 14. A Kiosk interface 90 also connects Kiosk 16 to bus 70 so that commands and data representative of a digitally represented digital image may be sent through a communication path 92. A printer 94 and an image processing device 96 are connected to bus 70 through serial port 74. After the print order data file is uploaded to photofinisher through network 20, from Kiosk 16, or using one or more of the drives connected to bus 70, a central processing unit (CPU) 98 may instruct printer 94 or image processing device 96 to produce the print of the still image on a print medium. Printer 94 is generally used to print the still image included in the print order data file on print medium such as photographic paper and other types of paper in various sizes and shapes. Image processing device 96 is generally used to print the still image on other types of medium that printer 94 cannot accommodate such as, but not limited to, posters, mugs, calendars, mouse pads, magnets, ornaments, plates, puzzles, and T-shirts.

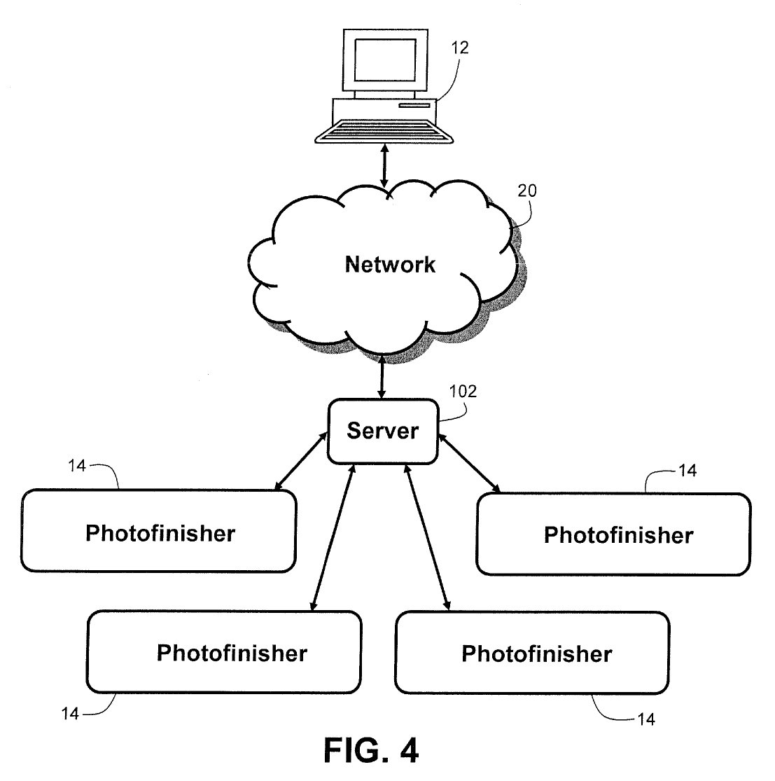

Photofinisher 14 also includes a system memory 100 that may be used to store image data uploaded from remote computer 12 through network 20, from Kiosk 16, or through any of the components 80, 82, 84, 86, 88. However, as best seen in FIG. 4, the system and method of the present invention may be used in other networking environments including a server 102, wherein server 102 may be positioned in between a plurality of photofinishers 14 and network 20. Server 102 may operate as a router to direct the print order data files originating from remote computer 12 to the photofinisher 14 designated by the user during the ordering process. In addition, server 102 may also provide a memory that stores all of the image data and print order data files uploaded from remote computer 12 to provide a central memory storage location so that the capacity of system memory 100 of photofinisher 14 may be reduced.

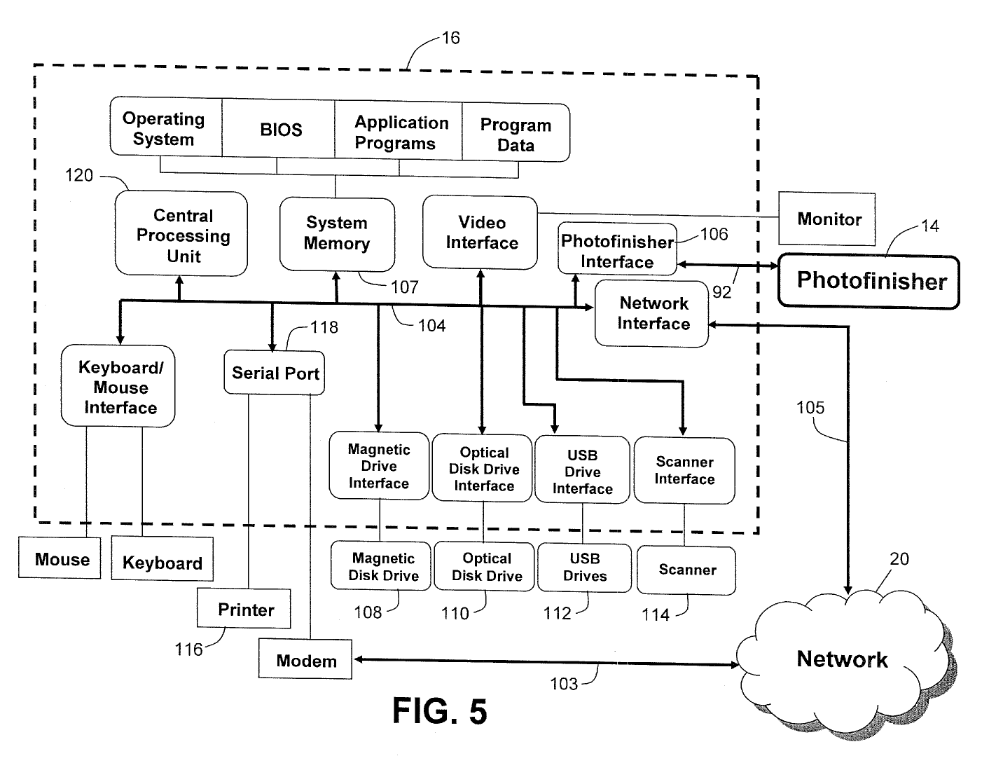

An exemplary Kiosk 16 is shown in FIGS. 1 and 5 and includes many of the components and capabilities that were described with respect to photofinisher 14. In general, the Kiosk 16 is a satellite or smaller version of photofinisher 14 that is positioned at a different location relative to photofinisher 14, while still being connected to photofinisher 14 through communication path 92 using a photofinisher interface 106, which is in turn connected to a bus 104. Kiosk 16 occupies less space compared to photofinisher 14 and therefore may be conveniently located within a store. The Kiosk 16 is usually connected to network 20 through a communication path 103 using a modem, or through communication path 105 using a network interface. However, some individuals may not have access to network 20, such as the Internet. Therefore, these individuals may physically bring a removable memory storage device (e.g., CD, floppy disk, flash memory) with the print order data file stored thereon and upload the print order data file to a system memory 107 using one of a magnetic drive 108, an optical drive 110, USB drives 112 or another type of drive. The user may also upload a still image to Kiosk 16 using a scanner 114. Kiosk 16 further includes a printer 116 and a serial portion 118 connected to bus 104 so that Kiosk 16 may be used to print still images included in the print order file on photographic paper or other types of paper in various sizes and shapes. In the instance where the print order data file includes instructions to print at least one of the still images on another type of medium that printer 116 cannot accommodate such as, but not limited to, mugs, calendars, mouse pads, and magnets, ornaments, plates, puzzles, and T-shirts, a central processing unit 120 may send an instruction to photofinisher 14 through at least one of communication paths 92, 103, 105 so that image processing device 96 (FIG. 3) can process that portion of the order and deliver the item to the user or a third-party designated by the user.

The system and method of the present invention allow the user to conveniently prepare a print order using a computing device that is remote from the photofinisher or Kiosk, and subsequently establish communication with the photofinisher or Kiosk through a network or by physically taking the print order to the photofinisher or Kiosk. Although the system and method are described as being implemented in an exemplary embodiment set forth herein it would be recognized by one skilled in the art that the system and method could be implemented with other types of photo organizing and editing software packages. It will be understood that the method of the present invention in the form of executable commands or instructions may be stored on or otherwise embodied within any type of computer-readable medium including, but not limited to, floppy disks, conventional hard disks, read only memory (ROM), random access memory (RAM), flash memory, electrically erasable programmable read-only memory (EEPROM), or other types of memory, magnetic cassettes, magnetic tape, magnetic disk storage or other magnetic storage devices, CD-ROM, digital versatile disks (DVD) or other optical disk storage, or any other medium which can be used to store the desired information and which can be accessed by the system disclosed herein.

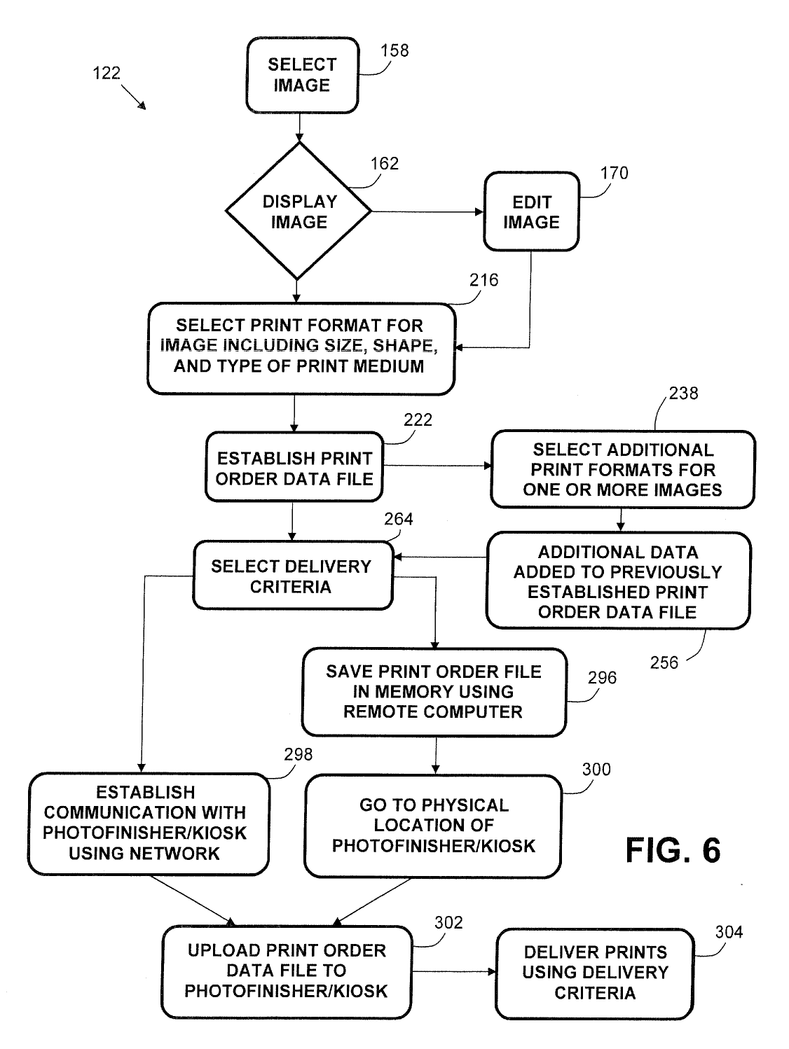

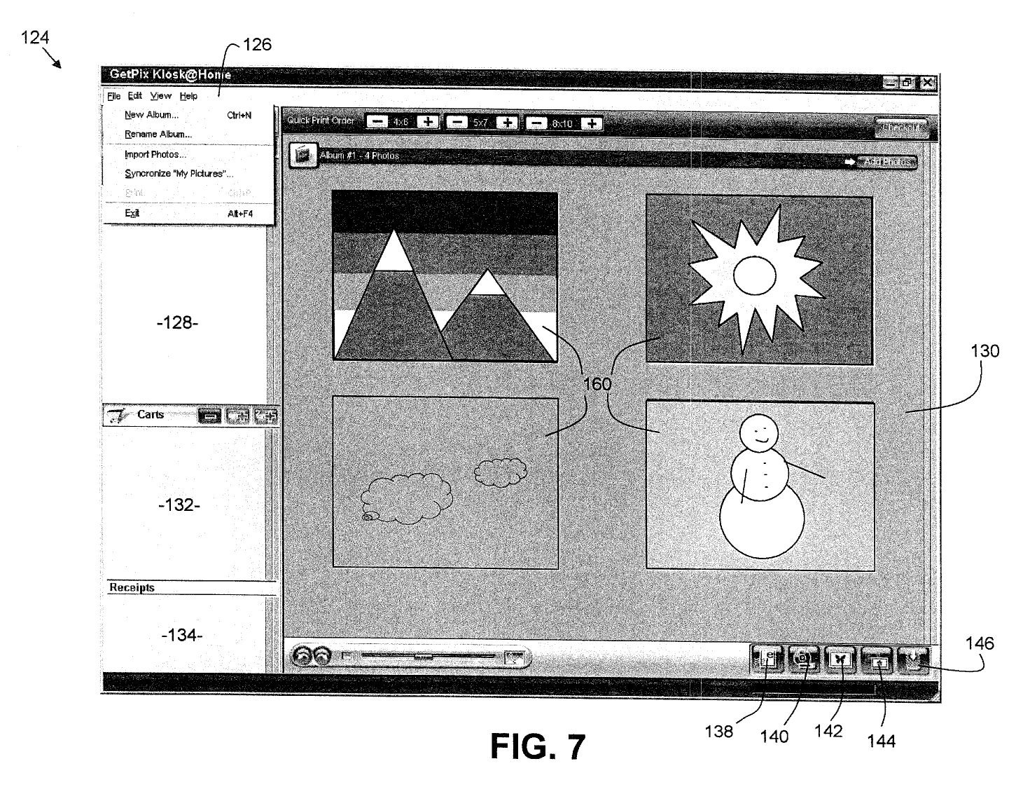

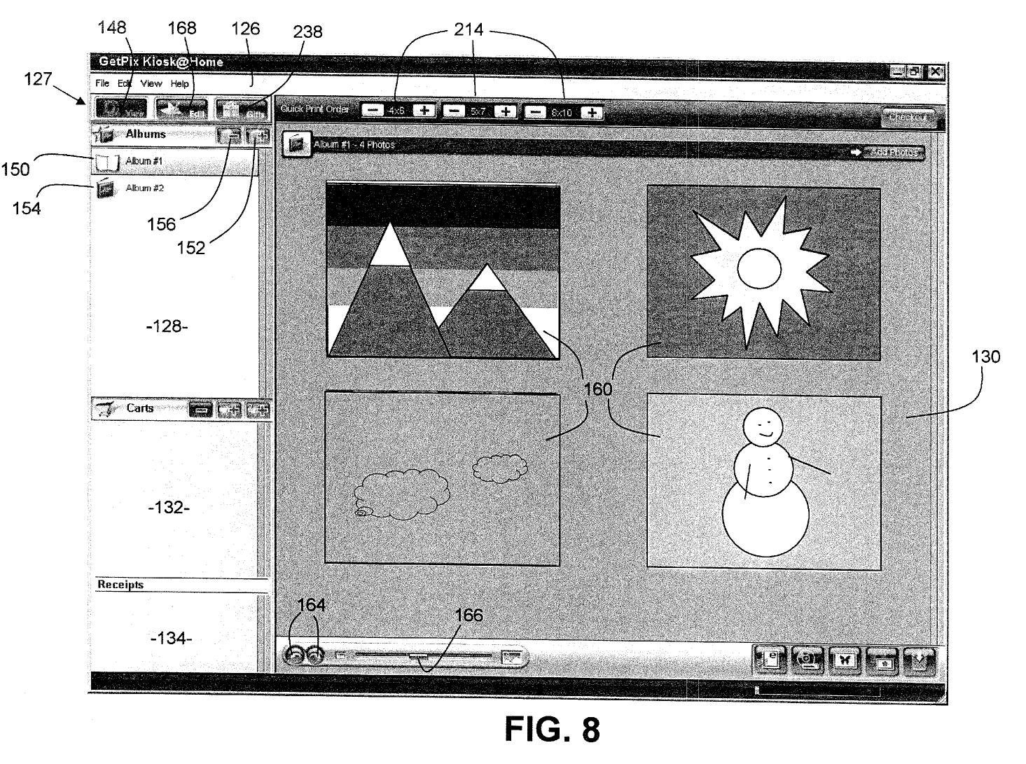

A method 122 in accordance with a first embodiment of the present invention is shown in FIG. 6 and will be described with reference to the Digital Album Organizer (DOA) software application 124 represented by the screen illustrations shown in FIGS. 7-15. As best seen in FIGS. 7 and 8, the user typically opens the application and downloads, imports or otherwise opens at least one image data file using a toolbar 126, wherein each image data file represents a digitally represented still image. At step 158, the image data files may be selected, downloaded or imported from a memory location 36 located on remote computer 12, removable memory storage device (e.g., CD, floppy disk, flash drive) using drives 52, 54, 56, 45, 58, or another type of computer-readable medium having a memory.

The user interface provided by the application is presented in an application window and includes a main selection pane 127 that allows a user to designate a view mode 148, an edit mode 168, or a gift mode 236. In addition the application window includes an album pane 128 in which one or more albums may be displayed, each album including one or more images that have been opened using the application. The application window may also include a picture pane 130 within which images from a currently selected album from album pane 128 are displayed, a print order pane 132 that displays print orders established by the user, and a receipt pane 134 that displays receipts confirming that photofinisher 14 has received, processed or otherwise completed the print orders that were communicated from remote computer 12. A plurality of buttons are also displayed in a button bar 136 having separate executable commands which allow the user to e-mail a selected image 138, archive a selected photo into a selected memory location 140, using a selected image as wallpaper 142 for the remote computer 12, display the selected images in a slide show or as a screen saver 144, and remove the selected images from the album 146.

Once each of the image data files are downloaded, the application automatically provides an execution command that places the application in view mode 148 and places each of the image data files in an album 150 (e.g., Album #1) that is displayed in album pane 128, as best seen in FIG. 8. In addition, the application provides an execution command that automatically selects album 150 located at the top of album pane 128 thereby displaying images 160 located within that album in picture pane 130, as best seen in FIG. 8.

Album pane 128 also may include a “Add Album” entry 152 having an execution command for adding an additional album 154 (e.g., Album #2) to the album pane 128, and a “Remove Album” entry 156 having an execution command for deleting one or more albums 150, 154 from album pane 128. Images may be moved from one album to another album by selecting the album where the image to be moved is located so that the image is displayed in picture pane 130, selecting the image to be moved with the user interface selection device, and dragging the image to the desired album located within album pane 128.

As best seen in FIGS. 6 and 8, in order to display a data file representative of a digitally represented still image, the user interface selection device may be used to select the album where the image is located. The picture pane 130 includes an area within which one or more images 160 from a currently selected album are displayed at step 162. Picture pane 130 includes a “Rotate” entry 164 having an execution command for rotating an image that is selected within picture pane 130, and a “Zoom” entry toggle bar 166 having an execution command for enlarging or reducing the size of a selected image displayed within picture pane 130. The larger the selected image is made in picture pane 130 using “Zoom” entry toggle bar 166, the fewer images that will be able to be viewed within picture pane 130. Likewise, the smaller the selected image is shown in picture pane 130 using “Zoom” entry toggle bar 166, the more images that will be able to be viewed within picture pane 130.

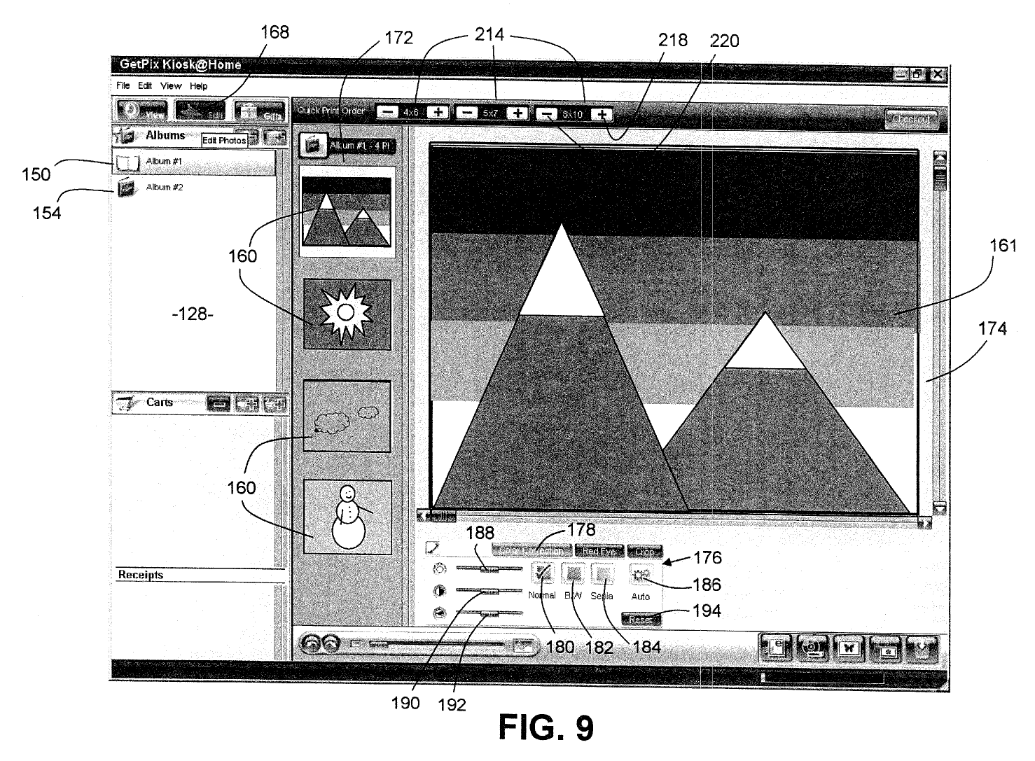

As best seen in FIGS. 6 and 9, main selection pane 127 further includes an edit mode 162 that allows a selected image located within picture pane 130 to be edited at step 170. The user may select edit mode 168 providing an execution command for displaying a sub-picture pane 172 for displaying images 160 located in the selected album 150, an image edit pane 174 for displaying an image 161 selected from sub-picture pane 172, and an edit tool bar 176 providing various editing tools for customizing image 161 displayed in image edit pane 174.

With specific reference to FIG. 9, edit tool bar 176 includes a “Color Correction” tab 178 having an execution command for displaying tools that relate to modifying the color of image 161 displayed in image edit pane 174. The tools related to the Color Correction tab 178 include a “Normal” entry 180 having an execution command for displaying image 161 using predetermined normal color characteristics, a “B/W” entry 182 having an execution command for displaying image 161 in black and white, a “Sepia” entry 184 having an execution command for displaying image 161 in a sepia format, and an “Auto” entry 186 having an execution command for automatically displaying image 161 using a predetermined set of characteristics provided in the application. Further, image 161 may be further edited within each of the Normal, B/W, Sepia, and Auto entries 180, 182, 184, 186 using a brightness slider bar 188, contrast slide bar 190, and a tone slide bar 192. Correction tab 178 also includes a “Reset” entry 194 having an execution command for resetting the characteristics of image 161 to its original state.

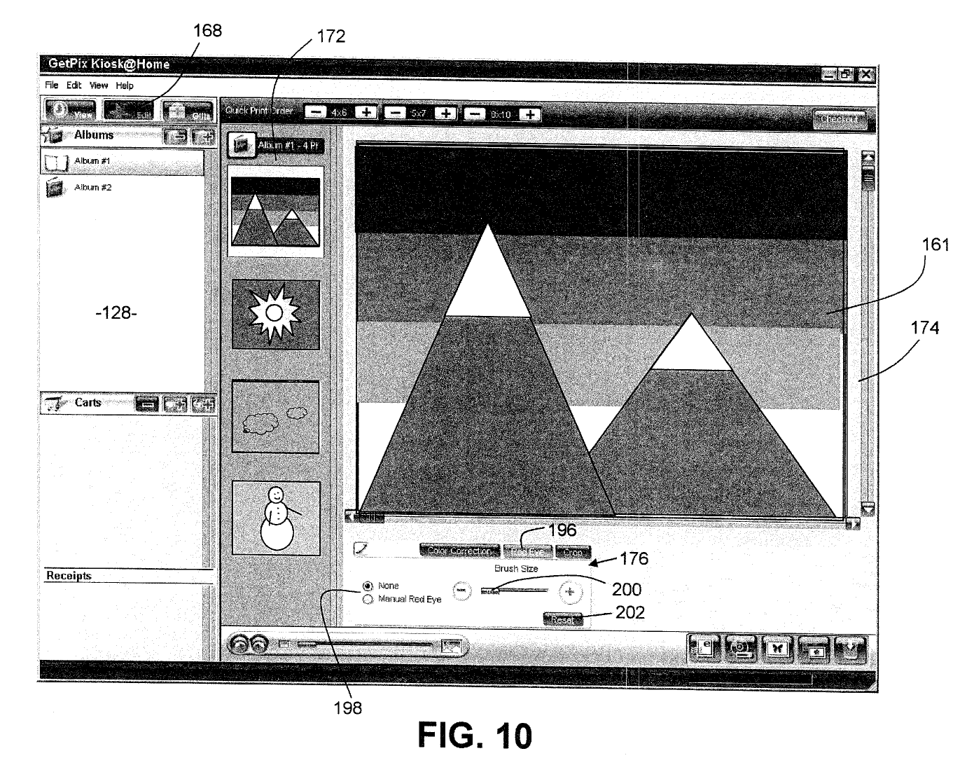

As best seen in FIG. 10, edit tool bar 176 also includes a “Red Eye” tab 196 having an execution command for displaying tools related to correcting red eye that may be present in image 161 displayed in image edit pane 174. The tools related to Red Eye correction tab 196 include a “Toggle” switch having an execution command for selecting if there is no red eye present in image 161 displayed in image edit pane 174 or if a manual red eye correction is desired by the user. If the manual red eye correction switch is activated, a brush size slide bar 200 is activated, which changes the user interface selection device to a red eye selection area (e.g., a circle) that is of a size determined by the position of brush size slide bar 200. The user interface selection device is manipulated by the user so that it is positioned over the red eye portion of image 161, and the user interface selection device is used (e.g., clicked) to produce an execution signal to eliminate or reduce the amount of red eye present in the selected area on the image. If brush size slide bar 200 is slid to the right, the red eye selection area will be larger than if brush size slide bar 200 is slid to the left. Red Eye tab 196 also includes a “Reset” entry 202 having an execution command for resetting the red eye characteristics to its original state.

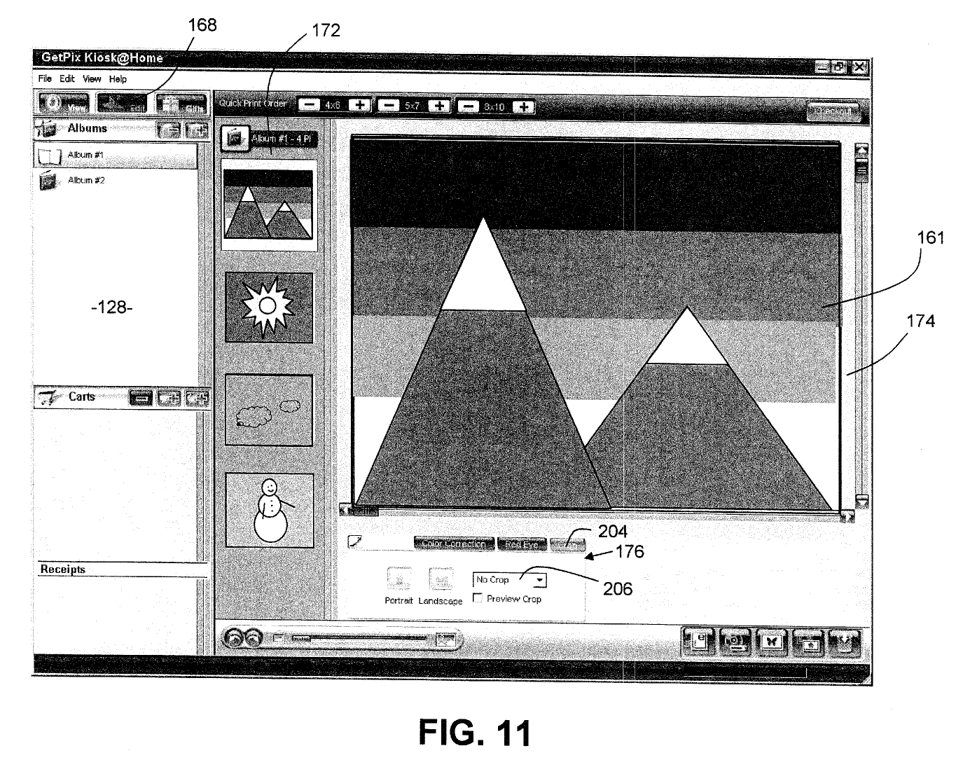

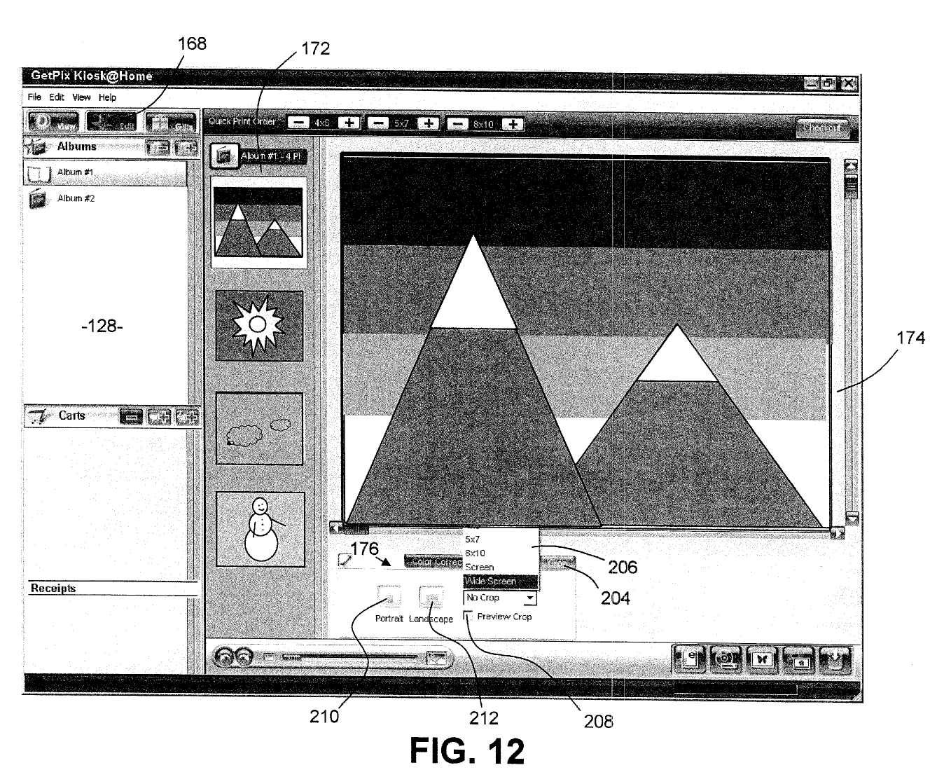

As best seen in FIG. 11, edit tool bar 176 also includes a “Crop” tab 204 having an execution command for displaying tools related to set the desired print area of image 161 displayed in image edit pane 174. In particular, the Crop tab 204 includes a “Pop-Up” menu 206 that provides the user with a number of preset crop configurations, as best seen in FIG. 12, such as wide screen, screen, 8×10, 5×7, 4×6, free crop, and no crop. It will be understood that the free crop menu selection allows the user to manually define the print area of image 161 located in image edit pane 174. After the print area has been selected using the Pop-up menu selections, a “Preview Crop” box 208 may be checked that allows the user to preview the cropped image in image edit pane 174 with the crop applied. In addition, if either the wide screen, screen, 8×10, 5×7, or 4×6 crop formats are selected, a “Portrait” entry 210 and a “Landscape” entry 212 both have an execution command that allows the user to set the page setup or orientation of the cropped print.

Referring back to FIGS. 8 and 9, the application also provides a “Print Order Selection” bar 214 having an execution command providing the user with the ability to select at least one print format for the image displayed in either picture pane 130 or sub-picture pane 172 at step 216. The print formats available in Print Order Selection bar 214 relate to the size and shape of the print, for example, 4×6, 5×7, and 8×10. It will be understood that more than one print format may be selected for image 160 displayed in picture pane 130 or sub-picture pane 172. Therefore, one 4×6 size print and one 5×7 print of the same image may be selected. Further, multiple copies of the same print format may be selected for the same image 160 displayed in picture pane 130 or sub-picture pane 172. For example, five 5×7 prints of the same image may be selected. The application provides a “+” entry 218 and a “−” entry 220 for each print format having an execution command allowing the user to add to or subtract from the number of print formats that may have been previously selected.

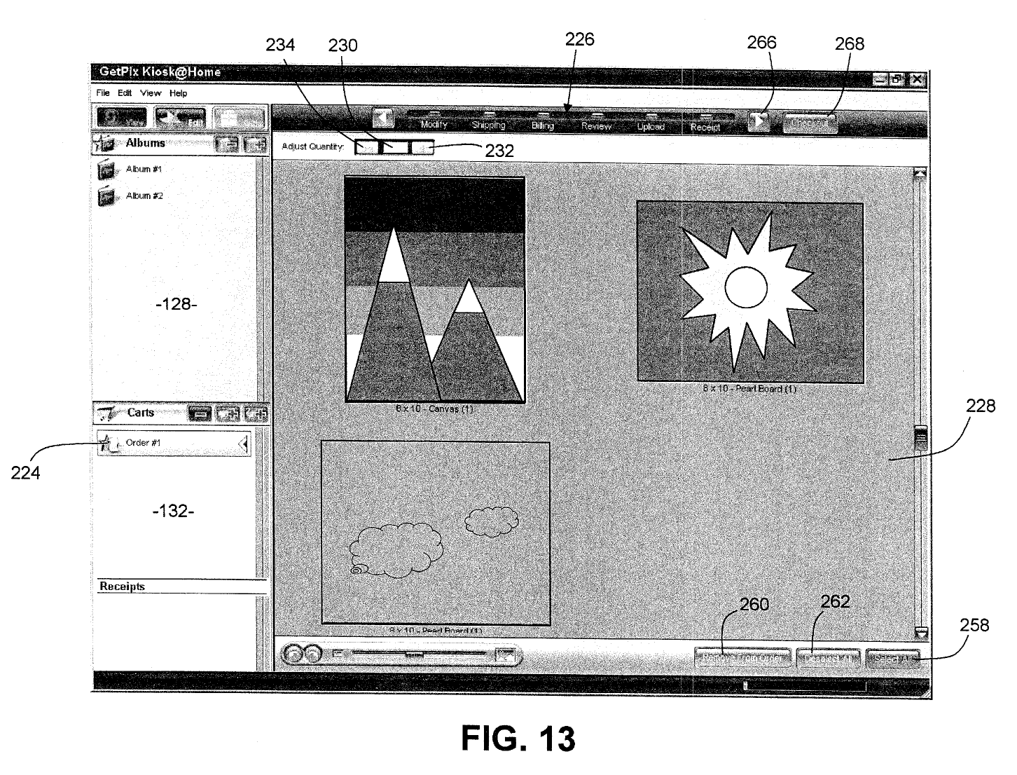

As best seen in FIGS. 6 and 13, upon receipt of the execution command indicative of a print format being selected using Print Order Selection bar 214, a print order data file is automatically established by the application at step 222 and is displayed in print order pane 132 as, for example, “Order #1.” A checkout progression sequence 226 is also displayed showing a checkout status of the in proceeding through the checkout process: modify, shipping, billing, review, upload, and receipt. The graphic display shown in FIG. 13 illustrates the modify portion of the checkout sequence, which allows the user to continue to modify the selected print order data file located in print order pane 132. By selecting the print order data file represented by “Order #1” in print order pane 132, the images included in the selected print order data file are shown in a print order display pane 228 indicating their selected print formats. While the print order display pane 228 is displayed, an “Adjust Quantity” box 230 having an execution command that allows the user to select additional print formats at step 238 or delete a print format that was previously selected by selecting the image displayed in the print order display pane 228 and entering the desired number of print formats for the selected image. The quantity of a print format for a selected image may also be adjusted using a “+” entry 232 and a “−” entry 234 having an execution command allowing the user to add to or subtract from the number of print formats that may have been previously selected.

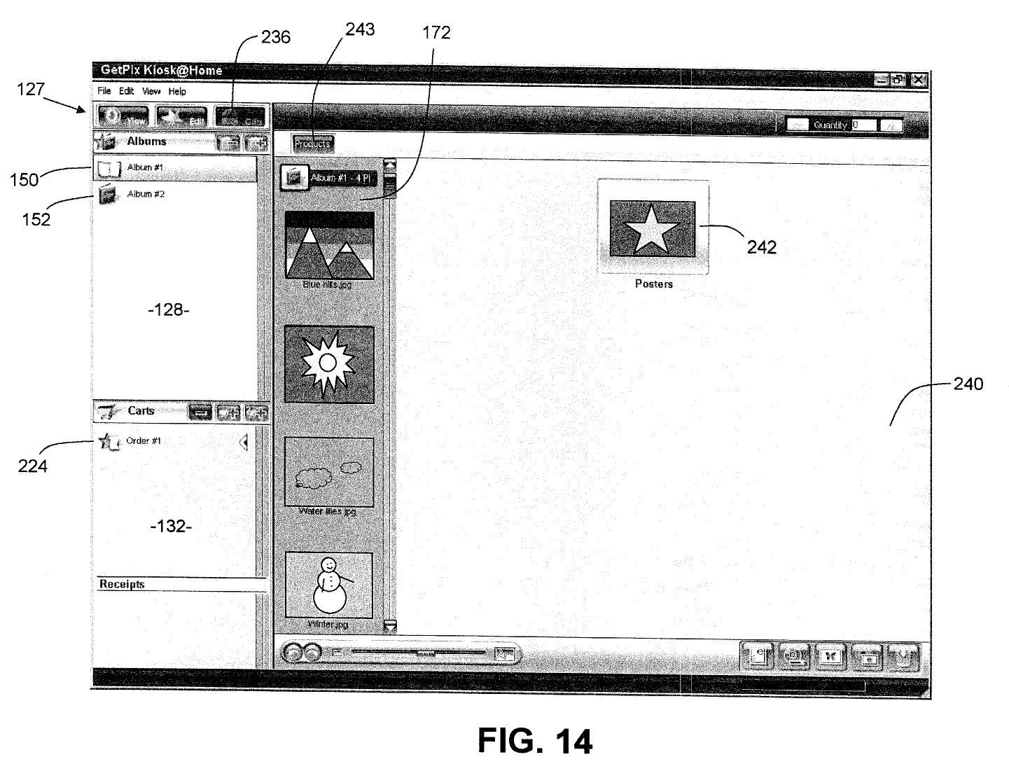

As best seen in FIGS. 6 and 14, main selection pane 127 also includes gift mode 236 that allows the user to further select additional print formats of one or more images at step 238. Specifically, the additional prints may be ordered using gift mode 236 include, but are not limited to, placing the image on posters, mugs, calendars, mouse pads, and magnets, ornaments, plates, puzzles, and T-shirts. With reference to FIG. 14, the user may select the gift mode 236 providing an execution command for displaying album pane 128, print order pane 132, sub-picture pane 172 that displays the images located in the selected album 150, and a gift option pane 240 for displaying an image indicative of a print medium, for example, a poster represented by a gift option entry 242. A “Products” entry 243 including an executable command for displaying the gift option is also provided upon selection of gift mode 236.

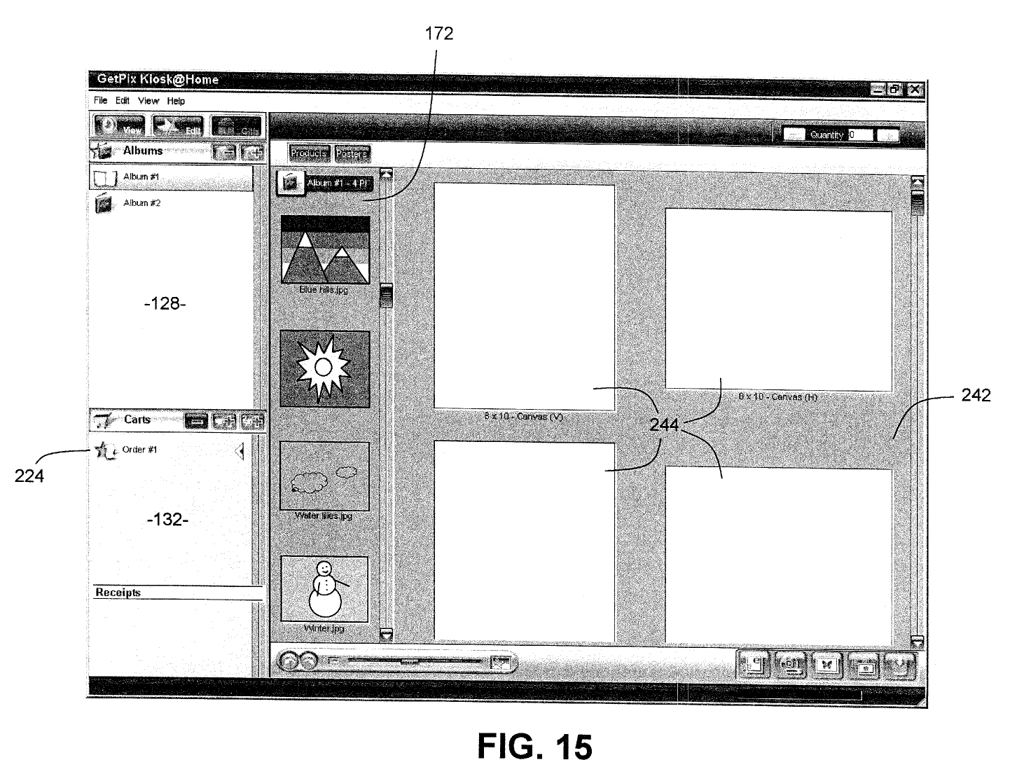

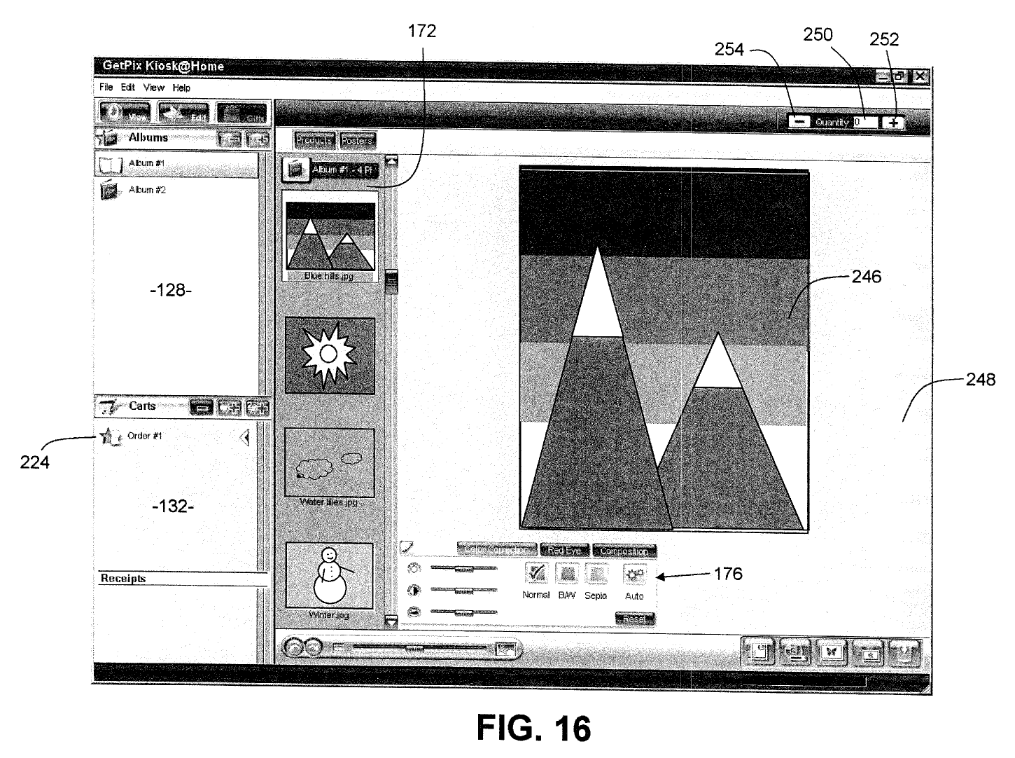

In selecting one or more additional print formats for image located in one of the albums 150, 154 using gift mode 236, one of the albums 150, 154 is selected thereby displaying the images located within the selected album in sub-picture pane 172. From the images displayed in sub-picture pane 172, one of the images is selected using the user interface selection device. One of the gift option entries 242 (only one shown) is then selected using user interface selection device which results in an execution command that displays a sub-gift option pane 242 as best seen in FIG. 15. Sub-gift option pane 242 includes one or more format alternatives 244 that the user may choose from which relates to the characteristics of the print formats, for example, the size and shape of the poster board that the image will be printed upon. One of the print format characteristics may be selected using the user interface selection device which results in an execution command that displays a selected image 246 using the print format characteristics in an edit gift option pane 248, as best seen in FIG. 16. Edit gift option pane 248 includes the edit tool bar 176 that allows selected image 246 to be edited, as was discussed above. While edit gift option pane 248 is displayed, a “Quantity” box 250 having an execution command allows the user to manually select the quantity of the gift print format by entering the desired number of prints for the selected image. The quantity of the gift print format for selected image 246 may also be adjusted using a “+” entry 252 and a “−” entry 254 having an execution command allowing the user to add to or subtract from the selected number of gift print formats.

As best seen in FIGS. 6, upon receipt of the execution command indicative of the additional print format being selected using “Quantity” box 250, additional data is added to the previously established print order data file at step 254. The step 256 of adding additional print formats to the print order data file (i.e., Order #1) may be repeated until the user has selected all of the desired print formats.

The user may then return to the checkout progression sequence 226 by selecting the print order file 224 located within the print order pane 132 using the user interface selection device so that the selected print formats are displayed in print order display pane 228, as best seen in FIG. 13. In the modify portion of the checkout progression sequence 226, the user interface selection device may be used to select one or more of the images located within print order display pane 228, or a “Select All” entry 258 has an execution command that allows all of the images located within print order display pane 228 to be selected at the same time. After one or more of the images located within print order display pane 228 are selected, a “Remove From Order” entry 260 has an execution command that allows the selected images to be removed from print order data file 224. A “Deselect All” entry 262 has an execution command that deselects all of the images that were selected by the user interface selection device or the Select All entry 258.

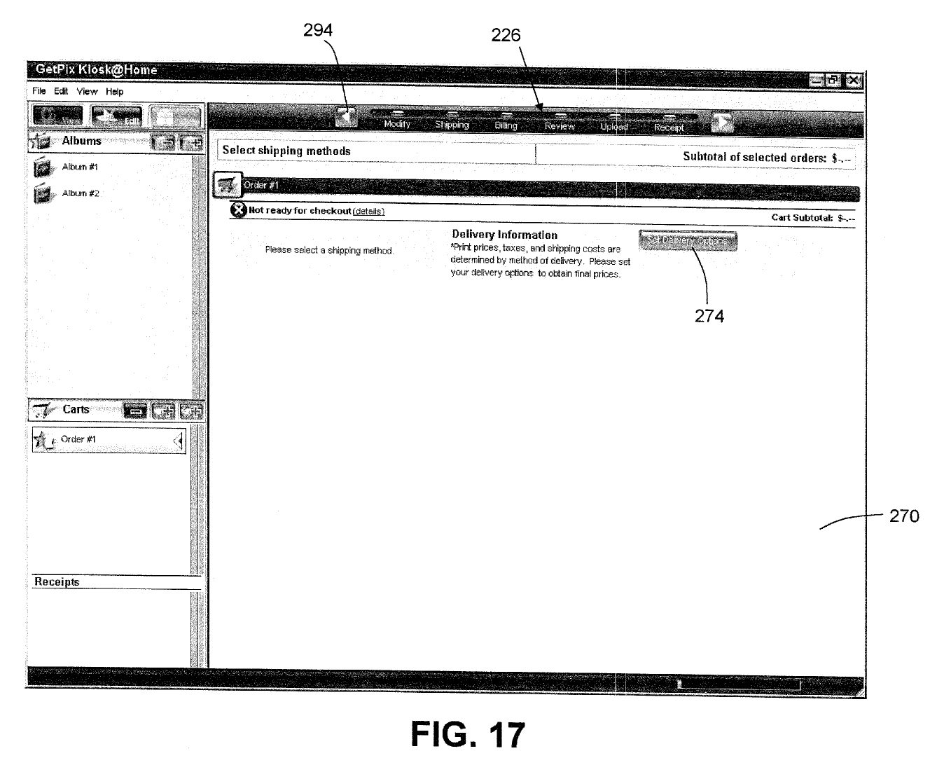

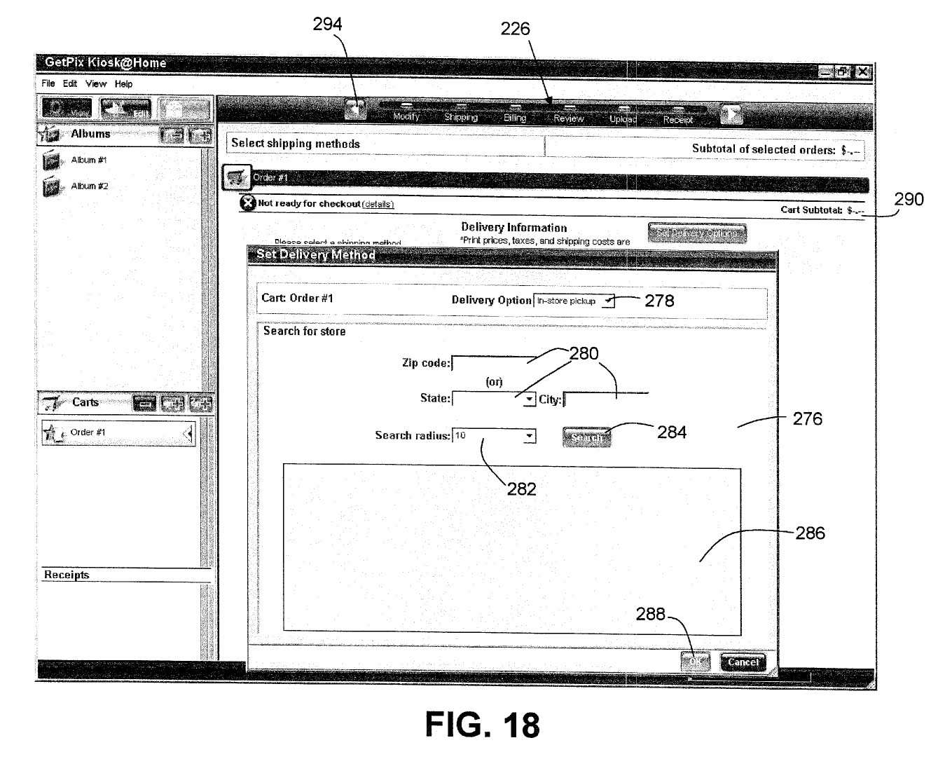

As best seen in FIG. 6, the user may then proceed to the shipping portion of the checkout progression sequence 226 for the print order data file 224 to select a delivery criteria for Order #1 at step 264. As best seen in FIG. 13, the user may use a forward arrow 266 or a “Checkout” entry 268 both having an execution command that displays a delivery criteria pane 270 as best seen in FIG. 17. The user may then select a “Set Delivery Options” entry 274 having an execution command that displays a “Set Delivery Method” window 276, as best seen in FIG. 18, having a “Delivery Option” drop-down menu 278 which includes the delivery criteria options of in-store pickup or mail to customer. In general, the delivery criteria may include a delivery location for the print, a delivery time for the print, and a delivery method for the print.

If the in-store pick-up option is selected, the application provides a number of entry fields 280 such as zip code, state, city, and a drop down menu 282 for a search radius to provide the user with a list of photofinisher 14 locations that fit the search criteria upon an execution command initiated by the selection of a “Search” entry 284. A photofinisher display pane 286 displays the photofinisher 14 locations that meet the search criteria to allow the user to select which store the print order is to be picked up.

If the mail to customer option is selected using Delivery Option drop-down menu 278, then the user is provided with a number of entry fields that allow for the entry of a desired delivery address where the prints are to be delivered, which may be the user's address or a third-party's address designated by the user. Also, entry fields may be provided to allow the user to enter the delivery time and method. Depending on the criteria of the print order data file, such as the type of item that the image is to be printed on, it is within the scope of the application to restrict the type of delivery options available to the user. For example, if the user places an order to print an image on a mug, the application may restrict the delivery options to only in-store pick-up. In addition, not all photofinishers may have the capability of printing the selected image on a mug, therefore the application may only display photofinishers in photofinisher display pane 286 that have the capability of processing the print order.

After the delivery criteria has been selected, the user may proceed to the billing portion of the checkout progression sequence 226 by selecting a “OK” entry 288 having an execution command that calculates and displays a “Cart Subtotal” 290 based on the items in the print order data file, the selected delivery criteria, and the pricing information for each of the print formats. The application then moves to a billing pane (not shown). The user may also select a “Cancel” entry 292 having an execution signal that closes the Set Delivery Method window 276. In the billing pane displayed by the application, the user enters information that can be used by the photofinisher 14 or Kiosk 16 to charge the user or a third-party designated by the user, or issue a bill the user or third-party based on the cart subtotal.

After the billing information has been selected, the user may proceed to the review portion of the checkout progression sequence 226 using forward arrow 266 to review all of the information previously entered during the checkout progression sequence 226. It will be understood that the user may also use a backward arrow 294 to return to the previous portion of the checkout progression sequence 226.

As best seen in FIGS. 1, 6 and 18, the application then proceeds to the upload portion of the checkout progression sequence 226 where the user is given the option to either save the print order data file (e.g., Order #1) in a memory location using remote computer 12 at step 296, or establish communication with at least one of photofinisher 14 and Kiosk 16 through network 20 at step 298. In step 296, with reference to FIGS. 1 and 2, the memory location may be system memory 36, a hard disk connected to hard disk drive 52, or removable memory storage media 18 such as, but not limited to, a CD, floppy disk, or flash drive that may be connected to remote computer 12. As best seen in FIGS. 1 and 6, if the user proceeds to step 296, the user may save the print order data file on a removable memory storage media 18 if it has not already been done, and physically take 22 the print order data file to the location of photofinisher 14 or Kiosk 16 at step 300. As best seen in FIG. 6, the print order data file is then uploaded or communicated to either photofinisher 14 or Kiosk 16 at step 302. In particular, as best seen in FIGS. 3 and 5, the print order data file may be uploaded to photofinisher 14 or Kiosk 16 using, for example, the magnetic disk drive 82, 108, optical disk drive 82, 110, USB drive 86, 112, or the scanner 88, 114.

A particular Kiosk of the present invention may use high speed and high capacity dye-sublimation printers, which can output a 4×6 print in 8 seconds. Additionally, a Kiosk of the present invention may comprise two 6 inch printers in tandem, capable of outputting 4×6 prints in as little as 4 seconds. Both Kiosks have the capability to make borderless 8×10 prints in just 40 seconds. The aforementioned Kiosk configurations comprise an intuitive and tilting touch screen terminal. Furthermore, the Kiosk may comprise unique media drive design, called “Intelligent Media Inserts,” which serves to minimize retailers' total cost of ownership. The Intelligent Media Inserts can be easily replaced by retailers, allowing for cost-effective expandability and maintenance, particularly as new storage media formats become available. The media slots, clearly visible and distinguishable from one another, accept the widest range of digital storage media—from standard drives to DVDs and even mini-CDs. In addition, the Kiosk may use Fujifilm's Image Intelligence for image enhancement and red-eye reduction.

The Kiosk may additionally provide the consumers the opportunity to upload their digital images from the comfort of their home for pick up at a Kiosk at their preferred retailer. In practice, the consumers upload their images from home and choose a retailer to print their digital images. Now, the Kiosk serves to expand this service to stores that do not have a traditional image printing device, such as the Frontier lab solution. Consumers may upload their images from home and choose a retailer to print their digital image via the Kiosk. Once the order is placed, they will receive a confirmation code that they will use at the Kiosk in-store to retrieve and print their digital photographs. This feature provides retailers with a way to offer their consumers more control and flexibility for ordering and picking up their digital photographs.

Furthermore, the Kiosk may include software which serves to provide retailers a flexible software solution allowing for three levels of printing service as well as the ability to offer photo specialty and wide format products. A single Kiosk may be configured to include three levels of service to print digital images: instantly, in an hour, or in a certain number of days. The Kiosk may be customized to meet various location requirements, providing retailers with flexible configurations that meet their business needs, creating a destination for consumers wherein orders can be ready instantly, for pick up after shopping, in 2 days, or in some other number of days. In addition, a high-resolution scanner allows consumers to easily produce copies or enlargements of their photographs. The Kiosk may be configured for any one or all of the following services: 1) self-service order station(s) that create and send customer orders for processing to an on-site Frontier minilab (multiple stations are available for greater ordering capacity and to reduce customer lines); 2) self-service print stations that print digital pictures instantly via two or three enclosed printers; or 3) Digital Dropbox that serves as a self-service drop box for photo gifts and print orders produced off-site.

As best seen in FIG. 6, the print order data file is then saved on system memory 100, 107 so that the order may be processed using printer 94, 116 or image processing device 96, and delivered to the user or third-party designated by the user using the selected delivery criteria at step 304.

As best seen in FIGS. 1 and 5, if the print order data file is uploaded to Kiosk 16, and Kiosk 16 is not capable of processing and delivering the print order due to the type of medium that the image is to be printed on (e.g., mug), the print order data file is transferred to photofinisher 14 through communication path 92 to process and deliver the order to the user or third-party designated by the user.

In the alternative, if the user proceeds with step 298, the user must establish communication with photofinisher or Kiosk only after reaching the upload portion of the checkout progression sequence 226. At step 298, as best seen in FIGS. 1 and 6, the user uses an order signal having an executable command that operates to establish communication with photofinisher 14 or Kiosk 16 and uploads the print order data file to photofinisher 14 or Kiosk 16 using one or more of communication paths 60, 62, 68, 72, 103, 105 at step 302. The print order data file may then be saved on system memory 100 so that the order may be processed using printer 94, 116 or image processing device 96. Instead of saving the print order data file on system memory 100, it is also within the scope of the present invention to save the print order data file on server 102 as best seen in FIG. 11, wherein the selected photofinisher 14 or Kiosk 16 communicates with server 102 to obtain the data necessary to process the print order. Notwithstanding where the print order data is stored, the prints are then delivered to the user or third-party designated by the user using the selected delivery criteria at step 304 as best seen in FIG. 6. An electronic receipt may then be sent to remote computer 12 and displayed in receipt pane 134 (FIG. 7).

Furthermore, while the remote computer is connected to photofinisher 14, Kiosk 16 or server 102, the application may also automatically or upon an update execution signal operate to receive an update related to the catalog of gift items available to be displayed on gift option pane 240 when the gift mode is selected (FIG. 14), an update related to the print sizes and shapes that are available in print order selection bar 214 (FIG. 8), and an update related to pricing information related to the print formats and delivery criteria that may be selected by the user in the shipping portion of the checkout progression sequence 226 (FIGS. 17 and 18).

The above described method allows the user to prepare the print order on remote computer 12 that is remote or otherwise disconnected from photofinisher 14 or Kiosk 16, which eliminates the need to be connected to network 18 while preparing the print order. As such, the method allows the user's phone line to stay open while preparing a print order for users that have a dial-up connection to the network. Further, using remote computer 12 also saves the user from having to spend extended periods of time at photofinisher 14 or Kiosk 16 while editing images and preparing the print order.

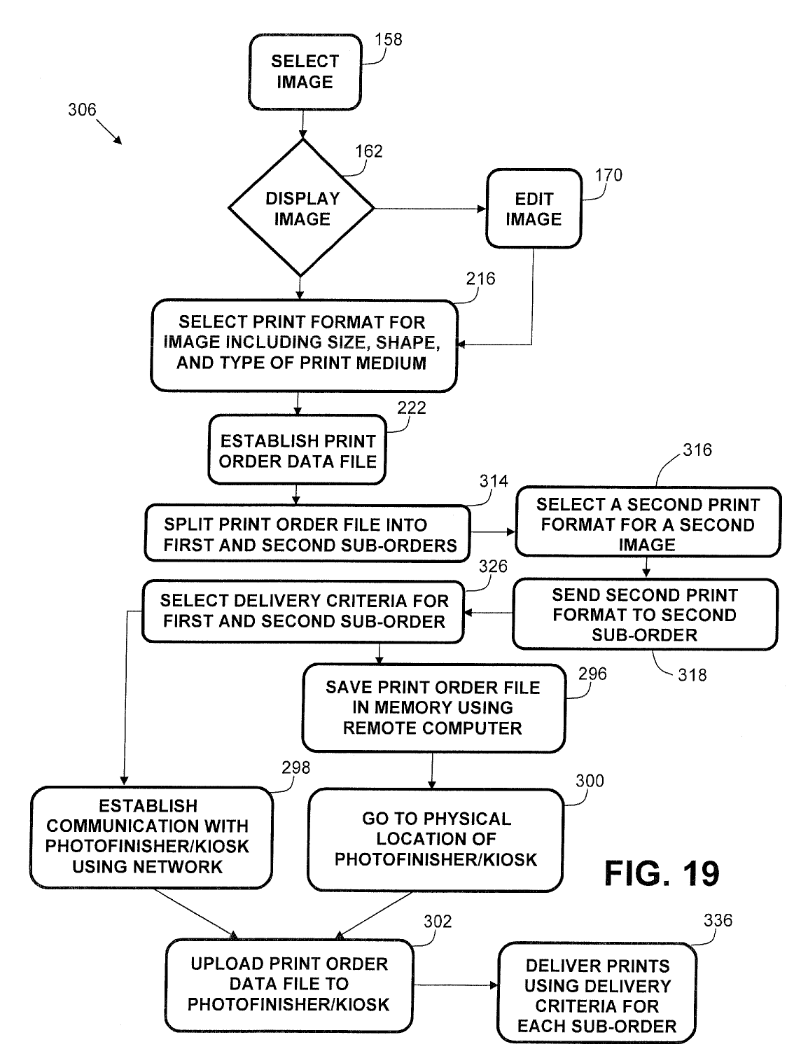

As best seen in FIG. 19, a method 306 in accordance with a second embodiment of the present invention is shown and may be implemented using the Digital Album Organizer (DOA) software 124 described above. In general, the second embodiment of the present invention relates to splitting the print order data file into at least first and second sub-orders thereby allowing the delivery criteria for each of the sub-orders to be independently selected. In describing the second embodiment 3067 some of the steps set forth in FIG. 6 are similar to those used in the method shown in FIG. 19.

With continued reference to FIG. 19, an image may be selected at step 158, displayed at step 162, and optionally edited at step 170. Further, a first print format is established for a first image including the size, shape and type of print medium that the first image will be printed on at step 216 thereby establishing a print order data file (e.g., Order #1) at step 222.

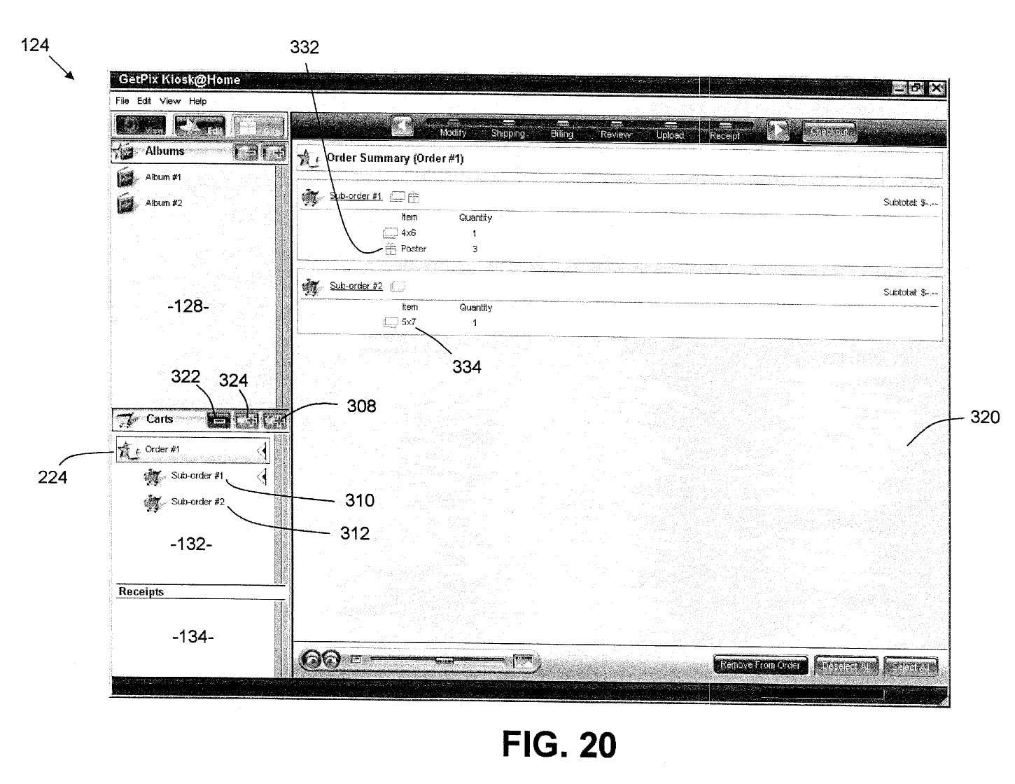

In accordance with the second embodiment of the present invention, and as best seen in FIGS. 19 and 20, the application includes a split cart entry 308 in print order pane 132 having an execution command that splits a selected print order data file 224 (e.g., Order #1) located within print order pane 132 into at least first and second sub-orders 310, 312 at step 314. A second print format is then established for a second image including the size, shape and type of print medium that the second image will be printed on at step 316. The second print format data for the second image may then be added to second sub-order 312 at step 318 by using the user interface selection device to select the second sub-order 312 prior to selecting the second print format using print order selection bar 214 (FIG. 8), or gift mode 236. It will be understood that the first and second images may be the same image, and the first and second print formats may be the same format type. For example, the user may want to order two 5×7 prints of the same image, wherein one of the 5×7 print formats is placed in the first sub-order and the other 5×7 print format is placed in the second sub-order.

As best seen in FIG. 20, by using the user interface selection device, the user may select print order data file (e.g., Order #1) located in print order pane 132 having an executable command for displaying an “Order Summary” window 320 that summarizes the contents of each of the sub-orders 310, 312 associated with the print order data file 224. Also, by using the user interface selection device, the user may select either sub-order 310, 312 located in print order pane 132 having an executable command for displaying the images associated with the selected sub-order. Print order pane 132 may also include a “Remove Selected Item” entry 322 having an executable command that deletes a selected print order data file 224 or a selected sub-order 310, 312 from print order pane 132. An “Add Cart” entry 324 having an executable command that adds a print order data file (e.g., Order #2) to print order pane 132.

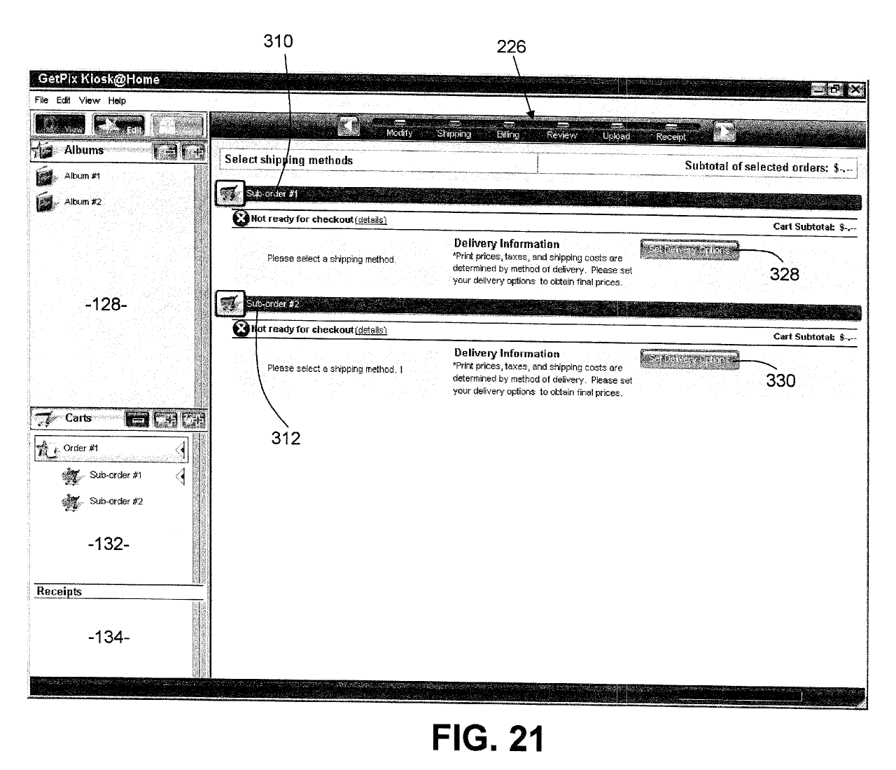

As best seen in FIG. 21, the user may then proceed to the shipping portion of the checkout progression sequence 226 for the print order data file 224 to select a delivery criteria for each sub-order 310, 312 at step 326, wherein each sub-order may include one or more print formats for one or more digitally represented still images. The user may then select a “Set Delivery Options” entry 328 associated with first sub-order 310 and a separate “Set Delivery Options” entry 330 associated with second sub-order 312. Each Set Delivery Options entry 328, 330 has an execution command that displays separate “Set Delivery Method” windows 276 similar to the one seen in FIG. 18 having a “Delivery Option” drop-down menu 278 which includes the delivery criteria options of in-store pickup or mail to customer, type of mail delivery (e.g., express or regular mail), and delivery destination, and a delivery time as was discussed in detail above.

After the delivery criteria has been selected for first and second sub-orders 310, 312, the user may generally proceed to the billing, review, upload, and receipt portions of the checkout progression sequence 226 as was described with respect to the first embodiment of the present invention as set forth above. In general, as best seen in FIGS. 1, 19, and 21, the application proceeds to the upload portion of the checkout progression sequence 226 where the user is given the option to either save the print order data file (e.g., Order #1) in a memory location using remote computer 12 at step 296 or establish communication with photofinisher 14 or Kiosk 16 through network 20 at step 298. If the user proceeds with step 296, the user may optionally save the print order data file on a removable memory storage media 18 if it has not already been done, and physically take 22 the print order data file to the location of photofinisher 14 or Kiosk 16 at step 300. As best seen in FIG. 19, the print order data file is then uploaded to either photofinisher 14 or Kiosk 16 at step 302.

In the alternative, if the user proceeds with step 298, the user establishes communication with photofinisher or Kiosk only after reaching the upload portion of the checkout progression sequence 226. At step 298, as best seen in FIGS. 1 and 19, the user uses an order signal having an executable command that operates to establish a connection with photofinisher 14 or Kiosk 16 and upload the print order data file using one or more of communication paths 60, 62, 68, 72, 103, 105 at step 302. The prints are then delivered to the user or third-party designated by the user using the selected delivery criteria for both first and second sub-orders 310, 312 at step 336 as seen in FIG. 19.

The second embodiment of the present invention allows the delivery criteria for first and second sub-orders to be independently determined thereby providing for an economical and timely delivery of the print order to the user or third-party designated by the user. For example, as best seen in FIG. 20, the first sub-order 310 may include a poster 332 that must be delivered to the user the next day, and the second sub-order 312 includes photographs 334 that do not have a specific delivery date, but must be delivered to a third-party designated by the user. Using the splitting order feature 308 in the application, the delivery criteria for the first sub-order 310 can be set at express delivery to the user, and the second sub-order 312 can be sent normal mail to the third-party, all contained within a single print order data file 224 that may be subsequently communicated to photofinisher 14 or Kiosk 16.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. In a system including a remote computer, a method for ordering a print of at least one digitally represented still image using the remote computer, wherein each still image is a separate data file, the method comprising the steps of:
selecting a data file representative of a digitally represented still image using the remote computer;
selecting a print format for the digitally represented still image;
establishing a print order data file which includes the selected print format for the digitally represented still image; and
subsequent to establishing the print order data file, establishing communication with at least one of a photofinisher and a Kiosk; and
downloading the print order data file to the at least one of the photofinisher and Kiosk, wherein the at least one of the photofinisher and the Kiosk produces the print of the digitally represented still image in the selected print format.

2. A method as recited in claim 1, wherein communication with the at least one of the photofinisher and the Kiosk is established using a networked connection.

3. A method as recited in claim 1, wherein the remote computer includes a graphical user interface including a display and a user interface selection device, the method further comprises the step of:
displaying the digitally represented still image on the display after the data file representative of the digitally represented still image is selected.

4. A method as recited in claim 3, further comprising the step of editing the digitally represented still image after the digitally represented still image is displayed.

5. A method as recited in claim 1, wherein the print format is a characteristic of the print of the digitally represented still image including size, shape, and type of print medium.

6. A method as recited in claim 5, wherein the print medium includes at least one of a poster, mug, calendar, mouse pad, magnet, ornament, plate, puzzle, or T-shirt.

7. A method as recited in claim 1, further comprising the step of:
selecting a delivery criteria after selecting a print format for the digitally represented still image, wherein the print order data file includes the selected print format and delivery criteria for the digitally represented still image.

8. A method as recited in claim 7, wherein the delivery criteria includes one of a delivery location for the print, a delivery time for the print, or a delivery method for the print.

9. In a system including a remote computer, a method for ordering a print of at least one digitally represented still image using the remote computer, wherein each still image is a separate data file, the method comprising the steps of:
selecting a data file representative of a digitally represented still image using the remote computer;
selecting a print format for the digitally represented still image;
establishing a print order data file which includes the selected print format for the digitally represented still image; and
saving the print order data file in a memory using the remote computer thereby allowing the saved print order data file to be subsequently communicated to a photofinisher to produce the print.

10. A method as recited in claim 9, further including the steps of:
subsequent to saving the print order data file in the memory, establishing communication with the photofinisher; and
downloading the print order data file to the photofinisher, wherein the photofinisher produces the print of the digitally represented still image in the selected print format.

11. A method as recited in claim 10, wherein the photofinisher includes a kiosk.

12. A method as recited in claim 10, wherein communication with the photofinisher is established using a networked connection.

13. A method as recited in claim 10, wherein communication with the photofinisher is established by the user going to the physical location of the photofinisher.

14. A method as recited in claim 9, wherein the data file representative of the digitally represented still image is stored in a memory of the remote computer.

15. A method as recited in claim 9, wherein the remote computer includes a graphical user interface including a display and a user interface selection device, the method further comprises the step of:
displaying the digitally represented still image on the display after the data file representative of the digitally represented still image is selected.

16. A method as recited in claim 15, further comprising the step of editing the digitally represented still image after the digitally represented still image is displayed.

17. A method as recited in claim 9, wherein the print format is a characteristic of the print of the digitally represented still image including size, shape, and type of print medium.

18. A method as recited in claim 17, wherein the print medium includes at least one of a poster, mug, calendar, mouse pad, magnet, ornament, plate, puzzle, or T-shirt.

19. A method as recited in claim 9, wherein the print order data file is saved in a memory in the remote computer.

20. A method as recited in claim 9, wherein the print order data file is saved in a removable memory.

21. A method as recited in claim 9, further comprising the step of:
selecting a delivery criteria after selecting a print format for the digitally represented still image, wherein the print order data file includes the selected print format and delivery criteria for the digitally represented still image.

22. A method as recited in claim 21, wherein the delivery criteria includes one of a delivery location for the print, a delivery time for the print, or a delivery method for the print.

23. A computer readable medium having computer-executable instructions for performing a method for ordering a print of at least one digitally represented still image using the remote computer, wherein each still image is a separate data file, comprising:
selecting a data file representative of a digitally represented still image using a remote computer;
selecting a print format for the digitally represented still image;
establishing a print order data file which includes the selected print format for the digitally represented still image; and
saving the print order data file in a memory using the remote computer thereby allowing the saved print order data file to be subsequently communicated to a photofinisher to produce the print.

24. The computer readable medium of claim 23, further comprising:
subsequent to saving the print order data file in the memory, establishing communication with the photofinisher; and
downloading the print order data file to the photofinisher, wherein the photofinisher produces the print of the digitally represented still image in the selected print format.

25. The computer readable medium of claim 24, wherein the photofinisher includes a kiosk.

26. The computer readable medium of claim 24, wherein communication with the photofinisher is established using a networked connection.

27. A method as recited in claim 24, wherein communication with the photofinisher is established by the user going to the physical location of the photofinisher.

28. The computer readable medium of claim 23, wherein the data file representative of the digitally represented still image is stored in a memory of the remote computer.

29. The computer readable medium of claim 23, wherein the remote computer includes a graphical user interface including a display and a user interface selection device, the method further comprises the step of:
displaying the digitally represented still image on the display after the data file representative of the digitally represented still image is selected.

30. The computer readable medium of claim 29, further comprising editing the digitally represented still image after the digitally represented still image is displayed.

31. The computer readable medium of claim 23, wherein the print format is a characteristic of the print of the digitally represented still image including size, shape, and type of print medium.

32. The computer readable medium of claim 31, wherein the print medium includes at least one of a poster, mug, calendar, mouse pad, magnet, ornament, plate, puzzle, or T-shirt.

33. The computer readable medium of claim 23, wherein the print order data file is saved in a memory in the remote computer.

34. The computer readable medium of claim 23, wherein the print order data file is saved in a removable memory.

35. The computer readable medium of claim 23, further comprising the step of:
selecting a delivery criteria after selecting a print format for the digitally represented still image, wherein the print order data file includes the selected print format and delivery criteria for the digitally represented still image.

36. The computer readable medium of claim 35, wherein the delivery criteria includes one of a delivery location for the print, a delivery time for the print, or a delivery method for the print.

37. In a system including a remote computer, the remote computer including a graphical user interface including a display and a user interface selection device, a method for ordering a print of at least one digitally represented still image using the remote computer, wherein each still image is a separate data file, the method comprising the steps of:
opening a data file representative of a digitally represented still image;
in response to an image selection execution command from the user interface selection device, displaying the digitally represented still image and one or more print format options in a picture pane on the display;
receiving a print format execution command from the user selection device indicative of the user selecting a print format for the digitally represented still image;
in response to the print format execution command, establishing a print order data file which includes the selected print format for the digitally represented still image; and
receiving a save execution command from the user interface selection device indicative of the user selecting to save the print order data file to a memory using the remote computer; and
in response to the save execution command, saving the print order data file in the memory using the remote computer thereby allowing the saved print order data file to be subsequently communicated to a photofinisher to produce the print.

38. A method as recited in claim 37, further including the steps of:
subsequent to saving the print order data file in the memory, receiving an order signal indicative of the user establishing communication with the photofinisher;
in response to the order signal, establishing communication with the photofinisher and downloading the print order data file to the photofinisher, wherein the photofinisher produces the print of the digitally represented still image in the selected print format.

39. A method as recited in claim 37, further comprising the step of:
selecting a delivery criteria after selecting a print format for the digitally represented still image, wherein the print order data file includes the selected print format and delivery criteria for the digitally represented still image.

40. A method as recited in claim 39, wherein the delivery criteria includes one of a delivery location for the print, a delivery time for the print, or a delivery method for the print.

41. In a system including a remote computer, a method of ordering a print of at least one digitally represented still image using the remote computer, wherein each still image is a separate data file, the method comprising the steps of:
selecting a first data file representative of a first digitally represented still image using the remote computer;
selecting a second data file representative of a second digitally represented still image using the remote computer;
selecting a first print format for the first digitally represented still image;
establishing a print order data file which includes the first print format for the first digitally represented still image;
splitting the print order data file into a first sub-order and a second sub-order, the first sub-order including the established print format for the first digitally represented still image;
selecting a second print format for the second digitally represented still image and placing second print format in the second sub-order;
selecting a first delivery criteria for the first digitally represented still image;
selecting a second delivery criteria for the second digitally represented still image, wherein the first and second delivery criteria are different; and
saving the print order data file including the first and second sub-orders in a memory using the remote computer thereby allowing the saved print order data file to be subsequently communicated to a photofinisher to produce the print.

42. A method as recited in claim 41, wherein the first and second delivery criteria includes one of the location that the print will be delivered, the time the print will be delivered, or the method by which the print will be delivered.

43. A method as recited in claim 41, further comprising the steps of:
subsequent to saving the print order data file in the memory, establishing communication with the photofinisher;
downloading the print order data file to the photofinisher, wherein the photofinisher produces the prints of the first and second digitally represented still images in the selected print format; and
delivering the prints of the first and second digitally represented still images in accordance with the first and second delivery criteria.

44. A method as recited in claim 43, wherein communication with the photofinisher is established using a networked connection.

45. A method as recited in claim 43, wherein communication with the photofinisher is established by the user going to the physical location of the photofinisher.

46. A method as recited in claim 41, wherein the photofinisher includes a kiosk.
